(19) United States
(12) Patent Application Publication
(10) Pub. No.: US 2019/0299390 A1
(43) Pub. Date: Oct. 3, 2019

(54) Knife With Ergonomic Handle

(71) Applicant: Silvano E. Salvador, South Lyon, MI (US)

(72) Inventor: Silvano E. Salvador, South Lyon, MI (US)

(21) Appl. No.: 16/365,993

(22) Filed: Mar. 27, 2019

Related U.S. Application Data
(60) Provisional application No. 62/648,993, filed on Mar. 28, 2018.
(60) Provisional application No. 62/728,111, filed on Sep. 7, 2018.

(51) Int. Cl. B25G 1/10; B26B 3/00

(52) U.S. Cl. CPC B25G 1/102; B26B 3/00

(57) ABSTRACT

A kitchen knife featuring a secure handle formed by an angled slot located above the cutting edge receiving the fingers of a user and a grip located above said slot and attached to the blade piece, the angling of the grip and slot eliminating any twisting of the user's wrist and having an ergonomic effect in executing cutting, chopping or a slicing motion with the knife.

### CROSS REFERENCE TO RELATED PATENT APPLICATION

This application claims the benefit of U.S. provisional patent application No. 62/648,993 filed on Mar. 28, 2018 and provisional patent application No. 62/728,111 filed on Sep. 7, 2018.

### BACKGROUND OF THE INVENTION

This invention concerns knives designed for general use in the home, such as in the kitchen for slicing and chopping vegetables, slicing meat, and pizza, as well as by fisherman/hunters filleting fish, skinning game, etc.

Conventional kitchen knives typically have a straight handle at one end projecting from the end of an elongated blade, the blade and handle fixed together end to end.

This arrangement has the disadvantage that the blade cutting pressure applied to what is being cut is not maximized by the arrangement aligned handle projecting from one end of the cutting blade since the handle is offset from the blade. In addition, the cutting edge is shortened since the knife handle necessarily occupies a substantial part of the overall length of the knife.

Furthermore the wrist of the person holding the knife by gripping such a handle must be turned and angled with respect to the blade when cutting something with the knife, stressing the wrist.

Thus, repetitive tasks such as chopping and slicing are laborious.

Also, the strength of the hold on the knife handle is reduced as the fingers and thumbs must be angled in order to hold a handle extending straight away from the user.

Improvements have been made in the past, such as curving the cutting edge to allow chopping by a rocking action of the blade, but this is still relatively laborious because of the angling of the wrist and fingers resulting from the handle location and orientation with respect to the blade.

U.S. Pat. No. 5,113,587 describes a knife having a handle attached to the rear end of the blade, angled up and projecting towards the front end of the blade.

However, the handle is connected to the blade by a narrow connection which is not sturdy and is vulnerable to breakage. This arrangement also does not provide good control over the movement of the blade when slicing meat or vegetables.

U.S. Pat. No. 4,117,593 show similar knife with the same deficiencies.

U.S. Pat. Des. No. 362,375 also does not enable good control of the blade, allowing twisting and swiveling of the handle and blade.

U.S. Pat. Des. No. 235,842 shows a straight handle aligned above one end of the blade, thus resulting in twisting of the blade when slicing.

U.S. Pat. Des. No. 404,633 is similar and suffers from the same defects.

A so called “ulu” knife is shown in U.S. D663,787 which is used for skinning and is not suited for general use in the kitchen since it requires a great deal of wrist action when used to slice meat or vegetables.

The object of the present invention is to provide a chef's knife which overcomes the described deficiencies by avoiding the need for twisting of a user's wrist when using the knife so as to reduce the effort required and allowing much better control over the knife blade movement so as to reduce the effort required and the increased effectiveness compared to prior art knives.

### SUMMARY OF THE INVENTION

The above recited objects as well as other objects which will be understood by those skilled in the art are achieved by a generally planar blade piece having a lower preferably curved cutting edge extending along the complete length of the blade piece from a front end to a rear end. An upper contour of the blade piece also extends from the front end to the rear end above the cutting edge, forming an elevated protuberance adjacent the rear end of the blade piece.

An elongated slot opening formed in the blade piece is angled with respect to the cutting surface and sized to receive the fingers of a user's hand when they are wrapped around an elongated grip extending just above the elongated opening. The slot and grip together form a handle The hold on the blade piece enabled by this handle is very secure since formed directly in the blade piece, and minimizes the effort required to use the knife.

The angle of the slot opening relative to the cutting edge is selected so that the wrist is aligned to eliminate any twisting of the user's wrist when the knife handle is gripped and achieves very good control over the movement of the blade when slicing, etc. The handle so formed is also very rugged and durable and provides excellent ergonomics by reducing the effort required to slice or chop vegetables, meat, etc.

The handle being located directly above the blade enables maximum cutting pressure to be exerted while the handle geometry achieves very good control over the knife cutting motion and maximizes the length of the cutting edge.

### DESCRIPTION OF THE DRAWINGS

FIG. 1 is a side elevational view of a knife according to the invention on a cutting surface shown with the hand of a user grasping the handle thereof.

FIG. 2 is a fragmentary enlarged view of a rear portion of the knife shown in FIG. 1 depicting a second slot formed in the knife blade piece to create a secure mounting of a molded grip, the second slot shown hidden lines in FIG. 1.

FIG. 3 is a view of the section 3-3 taken in FIG. 2.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

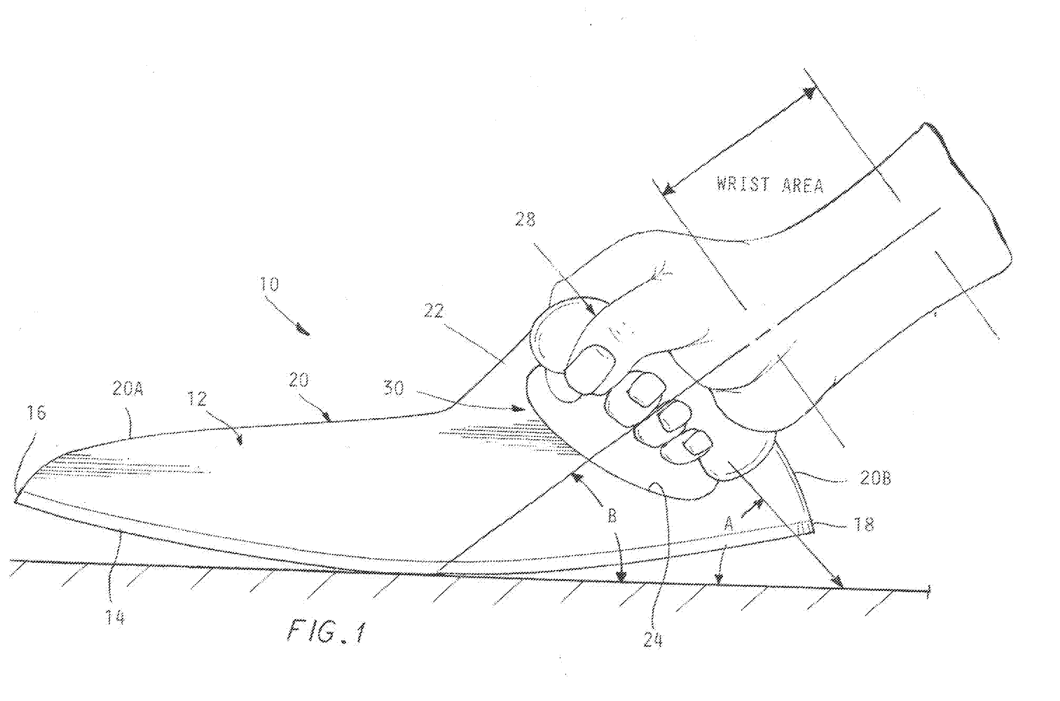

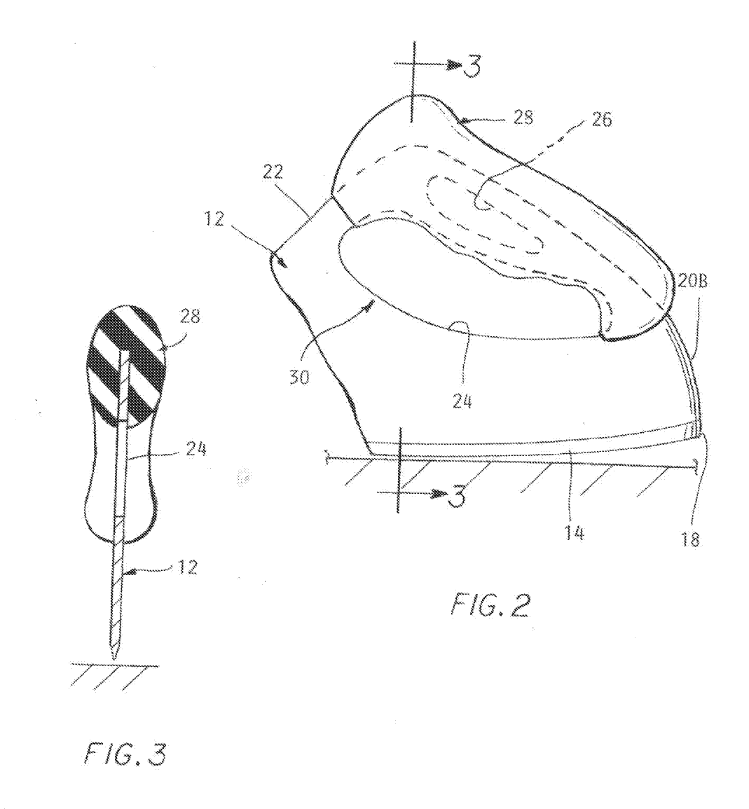

Referring to the drawings, and particularly FIG. 1, the knife 10 according to the present invention is comprised of a generally planar cutting blade piece 12, made of a knife grade stainless steel, preferably 440 series or equal of a thickness so as to be sufficiently stiff to avoid bending ⅛″ thickness having been found to be sufficient.

A sharpened cutting edge 14 extends completely across the bottom of the blade piece 12 from the front end 16 to the rear end 18.

The cutting edge 14 is preferably hollow ground and curved to facilitate effective chopping of vegetables, etc. by a rocking action. A cutting edge radius of 15 inches has been found to function well.

The blade piece 12 also has an upper contour 20 extending from the front end 16 to the rear end 18.

The upper contour 20 defines a protuberance 22 adjacent the rear end 18 of the blade piece 12. The upper contour protuberance 22 is formed by steeply a rising segment 20A at the rear end reaching a peak which then rounds over and extends down and blends into front portion 20B of the upper contour 20 which extends approximately parallel to the cutting edge 14.

An elongated slot 24 is formed within the protuberance 22 angled in an upward direction, approximately 45° from the cutting surface in direction towards the front end of the blade piece 12.

The slot 24 is sized to accommodate insertion of the fingers of one hand of the user.

A second slot 26 is formed in the blade piece at an angle to be substantially parallel and aligned with the first slot 24 is to anchor a molded plastic/rubber grip 28 just above the slot 24.

The upward angle of the slot 24 is approximately 45° plus or minus 5° so that for a work surface height in the range of 30 to 36 inches the wrist of the user is straight and not twisted when cutting with the knife 10 to reduce strain and thereby to be ergonomical.

The angle of the grip 28 and slot 24 will be about 45°-55° to afford stability and control over the blade piece 12 when slicing, chopping, etc.

The grip 28 and angled slot 24 form a handle 30.

The unitary construction of the handle 30 integral with the blade piece 12 provides a secure nonslip hold on the blade piece 12 which provides very good control over the slicing, cutting, or chopping motion of the blade piece 12.

Another advantage is comprised by the knife 10 is the increased length of the cutting edge with the grip located above the cutting edge 14 to enable good cutting pressure to be applied by the user when slicing or chopping with the knife 10.

1. A knife comprising a planar metal blade piece having a sharpened cutting edge extending along a substantially complete length of said blade from a front end tip to a rear end;
said blade piece having an upper contour extending from above said cutting edge, said front end to said rear end said upper contour forming a protuberance adjacent said rear end of said blade piece having an elongated opening formed therein extending at an upwardly inclined angle towards the front end and sized to receive the fingers of a user's hand;
a grip attached to said protuberance and extending along and above said elongated opening able to be gripped by a user's hand with the fingers encircling said grips and entering said upwardly angled elongated opening said grip and opening together comprising a handle.

2. The knife according to claim 1 wherein said upwardly extending angle is approximately 45° plus or minus 5°.

3. The knife according to claim 1 wherein said upwardly inclined angle of said elongated opening causes a user's wrist to be substantially normal to said elongated opening to so that a user's wrist is normally straight with respect to said handle when said knife is being used on a cutting surface 30″ to 36″ high.

4. The knife according to claim 1 wherein said cutting edge is shallowly convexly curved from said front end to said rear end of said cutting edge.

5. The knife according to claim 4 wherein said curvature of said cutting edge is formed by an approximately 15 inches radius.

6. The knife according to claim 1 wherein said protuberance also has a second elongated opening parallel to said elongated opening receiving a user's fingers, said grip molded into said second elongated opening to thereby be securely attached to said blade piece.

7. The knife according to claim 1 wherein said cutting edge is hollow ground.

8. The knife according to claim 1 wherein said upper contour has a forward portion which extends roughly parallel to said cutting edge lying below said forward portion past a center of sad knife and thereafter curving steeply upwards to partially form said protuberance together with an upper contour portion adjacent to said rear end of said piece.
